(19) United States
(12) Patent Application Publication
(10) Pub. No.: US 2010/0203303 A1
(43) Pub. Date: Aug. 12, 2010

(54) Laminated Sheet

(76) Inventor: Angus Bruce Blaiklock, Artarmon (AU)

Correspondence Address: FITCH EVEN TABIN & FLANNERY, 120 SOUTH LASALLE STREET, SUITE 1600, CHICAGO, IL, 60603-3406, US

(21) Appl. No.: 12/699,682

(22) Filed: Feb. 3, 2010

(30) Foreign Application Priority Data
Feb. 4, 2009 (AU) 2009900409

(51) Int. Cl. B32B 27/30; B32B 37/18

(52) U.S. Cl. 428/212; 156/87

(57) ABSTRACT

A laminated sheet (10) including a first acrylic layer that is preferably flat and clear. The layer (10) is secured to a second acrylic layer (12) by means of an acrylic adhesive (13). Preferably the layer (12) is also flat and coloured.

### TECHNICAL FIELD

The present invention relates to laminated sheets and more particularly to laminated sheets including acrylic layers.

### BACKGROUND OF THE INVENTION

In architecture and design industries there is the demand for materials, particular sheet materials that provide enhanced light, colour and textural features while maintaining practical and functional objectives.

A disadvantage of previously known sheeting is that it has been relatively expensive to provide sheeting of a laminated structure, particularly if that laminated structure includes a clear layer and a colour layer.

### OBJECT OF THE INVENTION

It is the object of the present invention to overcome or substantially ameliorate at least one of the above disadvantages.

### SUMMARY OF THE INVENTION

There is disclosed herein a sheet of laminated construction, the sheet including:

a first acrylic layer;

a second acrylic layer; and

an acrylic adhesive located between the layers so as to secure the layers in a laminated relationship.

Preferably, said second layer and/or said first layer are clear.

In an alternative preferred form, said first layer and/or said second layer is/are coloured.

Preferably, each layer is generally planar.

Preferably, said sheet includes a protective film covering the first and/or second layer.

There is further disclosed herein a method of manufacturing a sheet of laminated construction, said method including the steps of:

providing a first acrylic layer;

providing a second acrylic layer;

locating an acrylic adhesive between the two layers; and

removing gas from within the chamber so as to reduce the pressure therein.

Preferably, both acrylic layers are flat.

Preferably, at least one of the acrylic layers has a protective film.

Preferably, the first and/or second acrylic layer is/are clear.

In an alternative preferred form, the first and/or second acrylic layer is/are coloured.

### BRIEF DESCRIPTION OF THE DRAWINGS

A preferred form of the present invention will now be described by way of example with reference to the accompanying drawings wherein:

FIG. 1 is a schematic parts exploded perspective view of a sheet of a laminated construction and a chamber to aid in forming the sheet; and

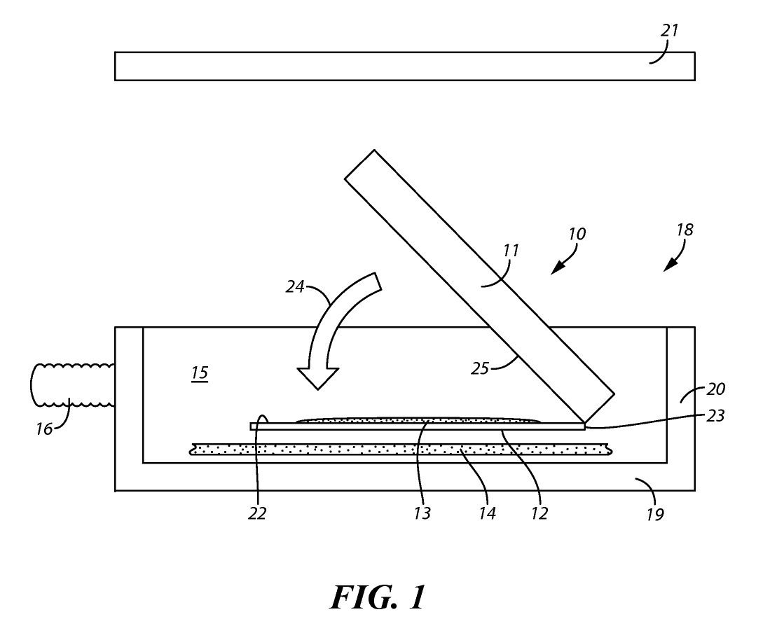

FIG. 2 is a schematic sectioned side elevation through the chamber and sheet of FIG. 1.

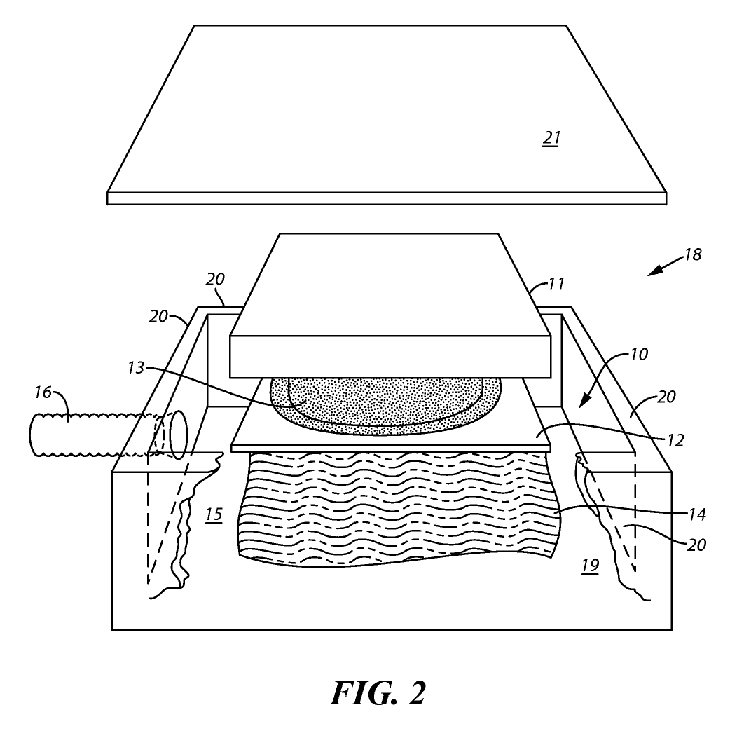

### DETAILED DESCRIPTION OF THE PREFERRED EMBODIMENTS

In the accompanying drawings there is schematically depicted a laminated sheet 10. The sheet 10 includes a first acrylic layer 11 that is preferably flat and clear. The layer 10 is secured to a second acrylic layer 12 by means of an acrylic adhesive (3:100) 13. In this preferred embodiment, the layer 12 is flat and coloured.

Applied to the external surface of the layer 12 is a protective film 14.

The layers 11 and 12 together with the adhesive 13 located therebetween is located in a closed chamber 15. Extending from the chamber 15 is a conduit 16 extending to a pump that removes gas from within the chamber 15 to lower the pressure therein. Typically the gas would be air.

Preferably, in constructing the sheet 10 the adhesive 13 is applied to the upper surface 22 of the layer 12 and the adhesive 13 spread over the surface 22 so that there is a margin adjacent the edges of the surface 22 that is not covered with an adhesive. However the adhesive does extend to the edge 23. The layer 11 is then applied to the surface 22 adjacent the edge 23 and pivoted in the direction of the arrow 24 until the lower surface 25 of the layer 11 engages the adhesive 13. When this occurs the adhesive 13 flows outwardly so as to cover the above discussed margin. This means of applying the layer 11 to the adhesive 13 and layer 12 minimises air being trapped between the layers 11 and 12. This constructed laminate 10 is then located in the chamber 15.

The chamber 15 is provided by a box 18 consisting of a floor 19 from which there upwardly extend four side walls 20. Sealingly engaged with the upper edges of the side walls 20 is a lid 21 that essentially closes the chamber 15. The lid 21 is removable to enable location of the sheet 18 in the chamber 15.

Upon the adhesive 13 setting under reduced gas pressure, air is allowed to re-enter the chamber 15 so that the lid 21 may be removed thereby providing access to the sheet 10 for its removal from the chamber 15.

1. A sheet of laminated construction, the sheet including:
a first acrylic layer;
a second acrylic layer; and
an acrylic adhesive located between the layers so as to secure the layers in a laminated relationship.

2. The sheet of claim 1, wherein said second layer and/or said first layer are clear.

3. The sheet of claim 1, wherein said first layer and/or said second layer is/are coloured.

4. The sheet of claim 1, wherein each layer is generally planar.

5. The sheet of claim 1, wherein said sheet includes a protective film covering the first and/or second layer.

6. The sheet of claim 2, wherein each layer is generally planar.

7. The sheet of claim 2, wherein said sheet includes a protective film

8. The sheet of claim 3, wherein each layer is generally planar.

9. The sheet of claim 4, wherein said sheet includes a protective film covering the first and/or second layer.

10. A method of manufacturing a sheet of laminated construction, said method including the steps of:
providing a first acrylic layer;
providing a second acrylic layer;
locating an acrylic adhesive between the two layers; and
removing gas from within the chamber so as to reduce the pressure therein.

11. The method of claim 6, wherein both acrylic layers are flat.

12. The method of claim 6, wherein at least one of the acrylic layers has a protective film.

13. The method of claim 6, wherein the first and/or second acrylic layer is/are clear.

14. The method of claim 6, wherein the first and/or second acrylic layer is/are coloured.

15. The method of claim 11, wherein at least one of the acrylic layers has a protective film.

16. The method of claim 11, wherein the first and/or second acrylic layer is/are clear.

17. The method of claim 11, wherein the first and/or second acrylic layer is/are coloured.

18. The method of claim 12, wherein the first and/or second acrylic layer is/are clear.

19. The method of claim 12, wherein the first and/or second acrylic layer is/are coloured.
